(19) United States
(12) Patent Application Publication
(10) Pub. No.: US 2009/0326965 A1
(43) Pub. Date: Dec. 31, 2009

(54) BULK MEDIA

(75) Inventor: Kamal Jain, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,458

(22) Filed: Jun. 26, 2008

(51) Int. Cl. G06Q 10/00; G06Q 30/00

(52) U.S. Cl. 705/1; 705/400

(57) ABSTRACT

The described implementations relate to bulk media. One technique allows a user to select songs to be installed on a media player device and installs the selected songs on the media player device. The technique also charges the user for the selected songs based on an amount of storage that the selected songs occupy on the media player device.

### BACKGROUND

Media players or media player devices, such as those that operate on the MP3 format continue to increase in popularity. Currently, a user or consumer buys a media player and then spends a large amount of time setting up the media player and installing media, such as songs. Acquiring a large selection of songs can be quite costly in this scenario, as songs are generally purchased at a flat fee per song. The time and/or cost commitments required to get a media player ready to actually use decrease consumer satisfaction. The present concepts offer more satisfying consumer scenarios.

### SUMMARY

The described implementations relate to bulk media. One technique allows a consumer to select songs to be installed on a media player device and installs the selected songs on the media player device. The technique also charges the consumer for the selected songs based on an amount of storage that the selected songs occupy on the media player device.

Another implementation is manifested as a system that includes a fee calculation module configured to track user selections of media for storage on a media player device and to charge the user based on an amount of storage used for the selected media. The system also includes a digital rights management module configured to restrict use of the media to the media player device. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an exemplary bulk media system in accordance with some implementations of the present concepts.

FIGS. 2-7 illustrate hypothetical screenshots of bulk media implementations in accordance with some implementations of the present concepts.

FIG. 8 illustrates an exemplary media bulk media system in accordance with some implementations of the present concepts.

### DETAILED DESCRIPTION

### Overview

This patent application pertains to bulk media. The term “bulk” is used in that the present concepts lend themselves for use with a large quantity of media such as hundreds or thousands of songs for a given user. In some cases, a user or consumer can select a media player device to purchase. The consumer can also specify an amount of media storage capacity for the media player device. For instance, in current implementations two gigabytes of storage capacity is sufficient for about 250 songs. So, if the consumer wants a thousand songs he/she can specify an eight gigabyte media storage capacity on the media player device. The consumer can then select enough songs to fill the capacity of the media player device. The selected songs can be automatically installed on the media player device. Viewed another way, the consumer can select the songs that he/she wants on the new media player. A media player model or configuration can then be automatically selected with sufficient capacity to store the selected songs. The songs can then be installed on the selected media player device for the user for a bulk rate fee.

From a financial perspective the present implementations allow a music supplier and music license holder(s) to make revenue from a consumer that is similar to existing models but the consumer can get a much greater amount of music for a comparable price. For instance, the consumer may pay about the same price as current models, but receive about 100 times more music (i.e., bulk media). Further, the consumer gains convenience in that music can be automatically installed on the consumer's media player device. Further still, the consumer rather than the supplier gets to select the music.

### Exemplary Configurations

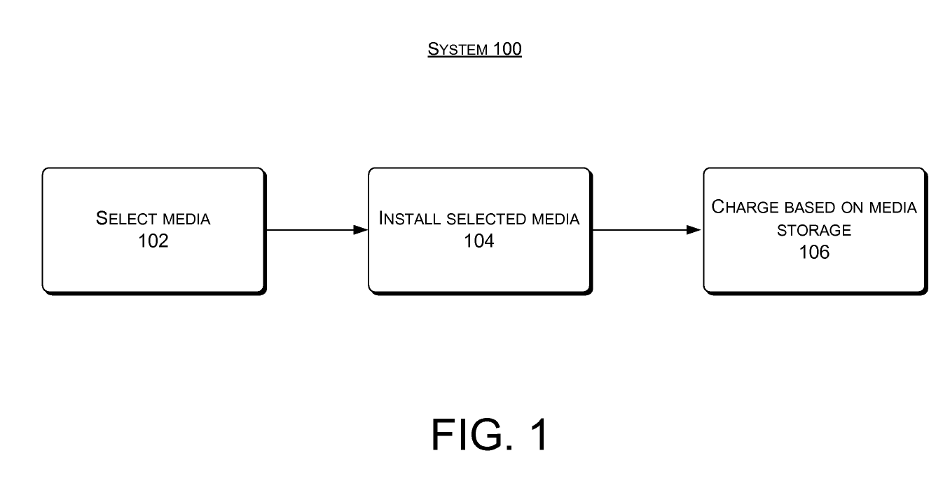

For discussion purposes consider introductory FIG. 1 which shows one bulk media system or technique 100. At 102 a consumer can select songs to be installed on a media player device. For instance, the consumer can select the media from an integrated web-site that offers both media player devices and the media that can be loaded on them. In some cases, the media that can be selected for the media player device can be restricted-use media meaning that the media can only be played on the media player upon which it was installed. For example, the restricted-use media cannot be copied by the user.

The selected songs can be installed on the media player device at 104. In some cases, the consumer may select the media player device upon which to install the songs. In other cases, suitable media player devices may be suggested for the consumer based at least in part on the songs selected by the consumer.

At 106, the consumer can be charged for the selected songs based on an amount of storage that the selected songs occupy on the media player device (i.e. charged at a bulk rate). For instance, assume that the consumer selected 250 songs that occupy 1.9 gigabytes of memory. The consumer could be charged for exactly 1.9 gigabytes of filled memory or for the closest available memory size that can handle 1.9 gigabytes, such as 2 gigabytes. In summary, this implementation can be thought of as charging the consumer per unit of memory occupied by the selected songs when installed on the medial player device.

The order in which the technique 100 is described is not intended to be construed as a limitation, and any number of the described blocks can be combined in any order to implement the technique, or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

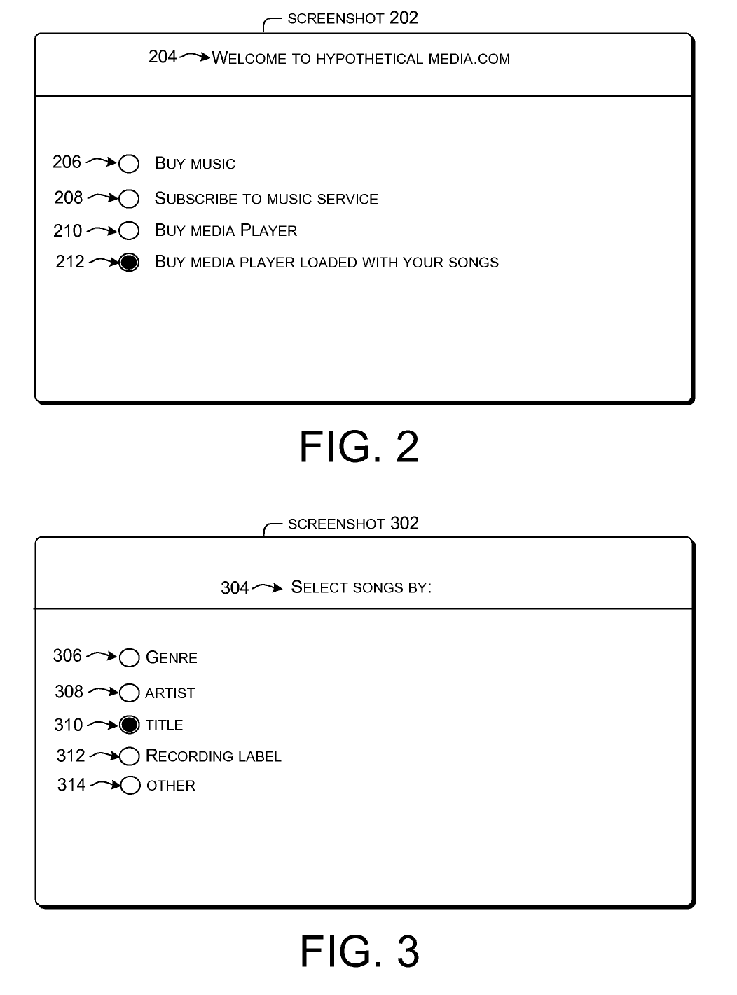

FIGS. 2-5 show a series of screenshots that illustrate several bulk media implementations.

FIG. 2 shows a screenshot 202 of a hypothetical media website 204. Screenshot 202 offers several media related options to a visiting consumer. For instance, at 206, the consumer can select a “buy music” option. At 208, the consumer can select a “subscribe to music service” option. At 210, the consumer can select a “buy media player” option. Finally, at 212 the consumer can select a “buy media player loaded with your songs” option. For purposes of explanation, assume that the consumer selects the “buy media player loaded with your songs” option 212.

FIG. 3 shows another screenshot 302 generated responsive to the user selection described above in relation to FIG. 2. At 304 the screenshot explains how the consumer can select songs for the media player device. The consumer can select by: “genre” 306, “artist” 308, “title” 310, “recording label” 312 or “other” 314. The “other” category 314 may include play lists established by the user or others. For instance, a social network for music aficionados may have complied lists of groups of songs that the user can select.

Assume for purposes of explanation that the consumer selects the “title” option 310. The consumer can then be presented with lists of songs by title and/or can enter search terms to receive a list of available song titles. Assume further that at the culmination of this process the consumer selects, for example, 503 songs. Of course, the number of songs selected (i.e., user-selections) in this example has no criticality relative to the inventive concepts and is instead offered simply for purposes of explanation.

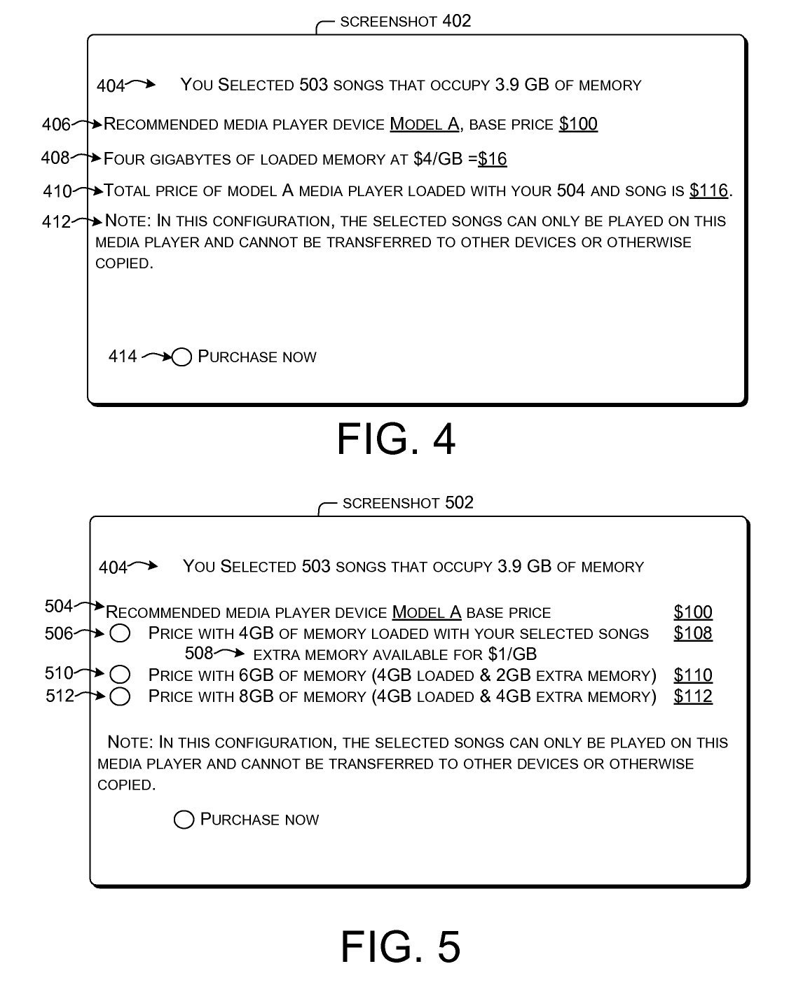

FIG. 4 shows another screenshot 402 generated responsive to the consumer's song selections mentioned above. In this case, line 404 indicates the number of songs selected (in this example “503 songs”). Line 404 also indicates that the 503 songs occupy (or will occupy) “3.9 gigabytes of memory” (i.e., amount of storage). Line 406 recommends a media player device based at least in part on the customer's song selections and/or associated storage requirements. In this example, the recommended media player device is a “Model A” that has a base price of “$100”.

Line 408 indicates that an additional charge of “$4/Gigabyte” to install “four gigabytes of loaded memory” which adds “$16” to the price. Four gigabytes of memory is utilized since 4 gigabytes may be the smallest available memory size that will hold the 3.9 gigabytes worth of songs selected by the consumer. (It should be recognized that the format of the songs and/or any compression techniques employed can affect the storage requirements for a given amount of music). Line 410 indicates that the total cost of the “Model A” media player device loaded with the consumer's selections is “$116” which is the sum of the base price plus the charge per gigabyte of loaded memory.

Line 412 includes terms of the purchase (i.e., purchase agreement). In this case, line 412 specifies that “In this configuration, the selected songs can only be played on this media player and cannot be transferred to other devices or otherwise copied.” Though not expressly stated on screenshot 402 for sake of brevity, exceptions may be made to this rule. For instance, should the media player device fail during a warranty period then the supplier may install the selected songs on a replacement media player device so that the consumer can play the songs for a remainder of the warranty period. Other and/or different terms may be included in other purchase agreements.

The consumer can select a “purchase now” option at 414 if the terms are agreeable to them. Upon completion of the transaction, the consumer can receive a media player device that is ready to use; no need to dock, or synchronize, or install music—just listen.

While screenshot 402 relates to a specific example where the user selects 503 songs that occupy roughly 4 gigabytes of memory, this implementation is scalable to any type of user. For instance, a casual user who only occasionally listens to songs on his/her media player device may only want one or two gigabytes worth of songs. In this scenario, the occasional user can get about ten-fold more songs than with existing scenarios where the user would purchase the media player device and then buy songs for about $1 each. For instance, assume that $20 of the $100 base price of the Model A media player device covers licensing royalties with recording artists and/or recording labels. Accordingly, assume that a comparable prior art media player device costs about $80 since it may not include a licensing royalty component. So, in the present implantation, the occasional user can get a media player device preloaded with about 250 songs selected by the user for about $104. Alternatively, the user could buy a traditional media player for $80 and have $24 dollars left over with which the user could buy about 24 songs to download on the media player device. Also, in the present implementation, the songs come preloaded on the media player device thereby offering a substantial time savings to the user compared with the traditional scenario.

In a similar fashion, a serious user that wants thousands of songs can get the songs much cheaper than present scenarios and the songs come preloaded on the media player device. For instance, say a serious user wants 10,000 songs. In existing scenarios, buying that many songs would be prohibitively expensive; something in the range of $10,000 plus the cost of the device. It is more likely that the serious user would have joined some type of subscription service where the user pays a monthly fee, such as $15 to have access to a large amount of songs. For purposes of explanation, the present discussion compares the costs of the present implementation and the previous scenarios over a three year period. In the existing scenario, the user has to buy the media player device for about $80 and pay $540 in subscription charges ($15/month×36 months) for a total of $620. In contrast, the implementation described in relation to FIG. 4 costs the user $420 ($100 for the media player device plus $320 for the songs (80 GB of songs at $4/loaded GB). Thus, the present scenario saves the serious user about $180 plus it offers the great convenience in that the media player is loaded with the music and ready to play when the user receives it.

In this implementation, the cost to the user on a per song basis is 4.2¢ (10,000 songs/$420) when considering both the hardware cost (i.e., storage) and the installation cost. Additional songs can be added for 1.6¢ per song at $4/loaded GB price (250 songs/$4). Some calculations may exclude the hardware costs since the hardware has other uses. In this case, the cost to the user on a per song basis for additional songs is 0.8¢ (250 songs/2$). In either case, the cost per song is so low that the user may tend to view the cost to load gigabytes of songs on the media player device as a service cost that provides convenience rather than as a per song cost. Essentially, once the user buys the media player device and pays the service fee additional songs can be added at a nominal (<2¢) price. As will be discussed in more detail below, in some implementations the price per additional song may approach or reach zero.

FIG. 5 shows an alternative implementation to screenshot 402 in the form of screenshot 502. This latter implementation distinguishes between overall storage capacity on the media player device and a sub-set of the storage capacity that is preloaded with the user's song selections. Stated another way, in this implementation the user can select both the songs to have pre-installed on the media player device and an overall amount of storage capacity on the media player device. Accordingly, this implementation recognizes that the user may want additional storage capacity on the media player device beyond that which is occupied by the preloaded songs. For instance, the user may want to have additional capacity to store future releases from their favorite artists.

Screenshot 502 continues with the example of FIG. 4 and begins with line 404 which specifies how many songs the user has selected and how much storage will be occupied by the selected songs. Recall that in this example, line 404 specifies that the user selected “503 songs that occupy 3.9 GB of memory”. Line 504 shows a suggested or recommended media player device for the user as a “Model A” with a base price of “$100”. In this case, memory loaded with the user's songs is offered at $2/GB so line 506 shows the price of the Model A as “$108” with “4 GB of memory loaded with your selected songs”.

Line 508 indicates that extra memory can be purchased for the media player device for “$1/GB”. This feature offers the user extra memory capacity beyond that occupied by the selected songs. Specifically, line 510 shows a price of “$110” for the Model A with “6 GB of memory (4 GB of loaded memory & 2 GB of extra memory)”. So the calculated price in line 510 of $110 includes the $100 base price plus $8 for loaded memory (4 GB at $2/GB) plus 2 extra GB of extra (i.e., empty) memory at $1/GB.

Similarly, line 512 shows a price of “$112” for the Model A with “8 GB of memory (4 GB of loaded memory & 4 GB of extra memory)”. So the calculated price in line 508 of $112 includes the $100 base price plus $8 for loaded memory (4 GB at $2/GB) plus 4 extra GB of extra (i.e., empty) memory at $1/GB.

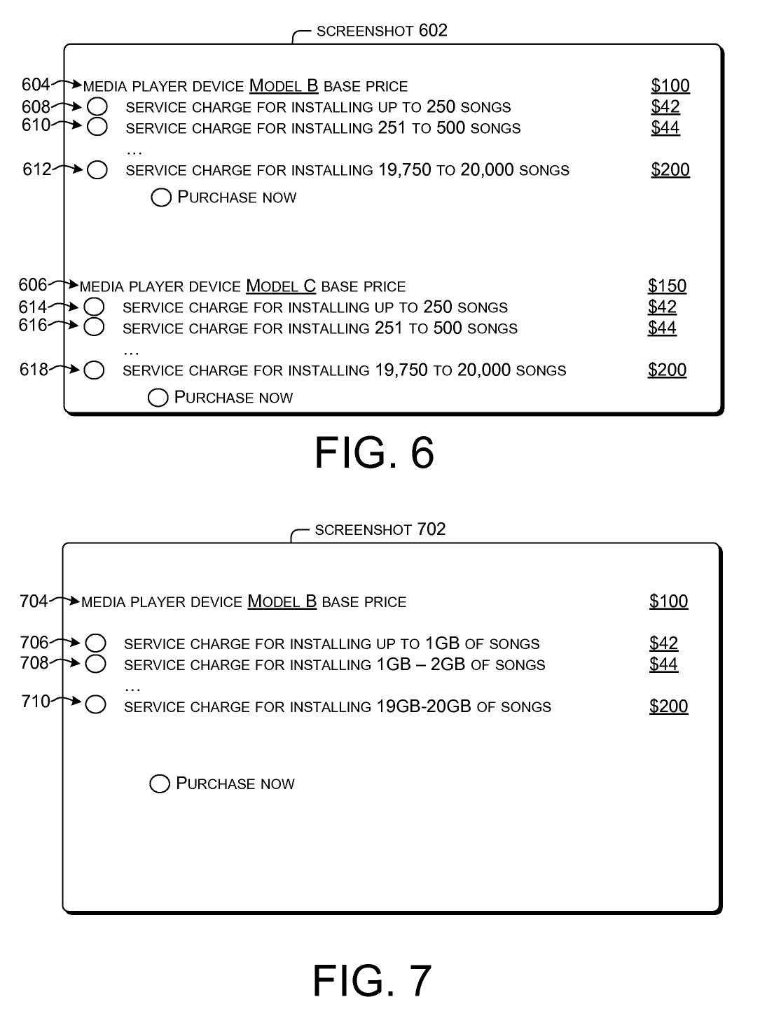

FIG. 6 shows a screenshot 602 from which the user can purchase a media player device. In this case, the cost of the media player device is distinguished from the “service” of installing songs on the device. For instance, this supplier offers two media player devices. Line 604 offers a “Model B” media player device with a base price of “$100”. Line 606 offers a “Model C” media player device with a base price of “$150”. Lines 608-612 show service charges for installing songs on the “Model B” media player device of line 604. Line 608 indicates that the “service charge for installing up to 250 songs” on the Model B is “$42”. Line 610 indicates that the “service charge for installing 251 to 500 songs” on the Model B is “$44”. Service charges for intervening number of songs are not shown for sake of brevity. Line 612 indicates that the “service charge for installing 18,750 to 20,000 songs” on the Model B is “$200”. In this example, while not expressly conveyed to the user, the service charge has a fixed component and a numerically variable component. For instance, in this case, the fixed component can be $40 and the variable component can be $2 per 250 songs.

Line 614 through line 618 relate to the “Model C” media player device of line 606 in an analogous manner to lines 608-612 relative to “Model B”. Even though the base price of the “Model C” media player device is higher than the “Model B” media player device ($150 versus $100) the service charges are comparable.

FIG. 7 shows another screenshot 702 that offers an alternative to the implementation described in relation to FIG. 6. Line 704 offers the “Model B” media player device with a base price of “$100” as in FIG. 6. Lines 706-710 show service charges for installing songs on the “Model B” media player device of line 704. Line 706 indicates that the “service charge for installing up to 1 GB” on the Model B is “$42”. Line 708 indicates that the “service charge for installing 1 GB-2 GB” on the Model B is “$44”. Service charges for intervening number of songs are not shown for sake of brevity. Line 710 indicates that the “service charge for installing 19 GB-20 GB” on the Model B is “$200”. This implementation derives the service charge relative to storage filled by the service of installing songs for the user rather than on the songs themselves.

As mentioned above, a portion of the service charge can go toward licensing royalties for the recording labels. The above implementations can drive competition between the recording labels in a manner that potentially benefits the user. For example, suppose for ease of explanation that the entire $40 service charge is proportionally divided among five record labels that provide the songs. Say for instance, that record label A has the most songs represented and as such gets $12 out of the $40. Label B gets $11, label C gets $8, label D gets $5 and label E gets $4. The labels may vie to position themselves to get more revenue from the user. For instance, label E only expects to receive $4 from a sale to the customer. Label E may decide to offer a playlist through the supplier that offers a complete package of their best hits for only $5. A consumer who is already going to spend somewhere around $100-$300 on a preloaded media player device is likely to spend the extra $5. Then the other labels (A-D) may come up with comparable offers of their own which ultimately increase the options and/or decrease the price for future users to purchase similarly equipped media player devices.

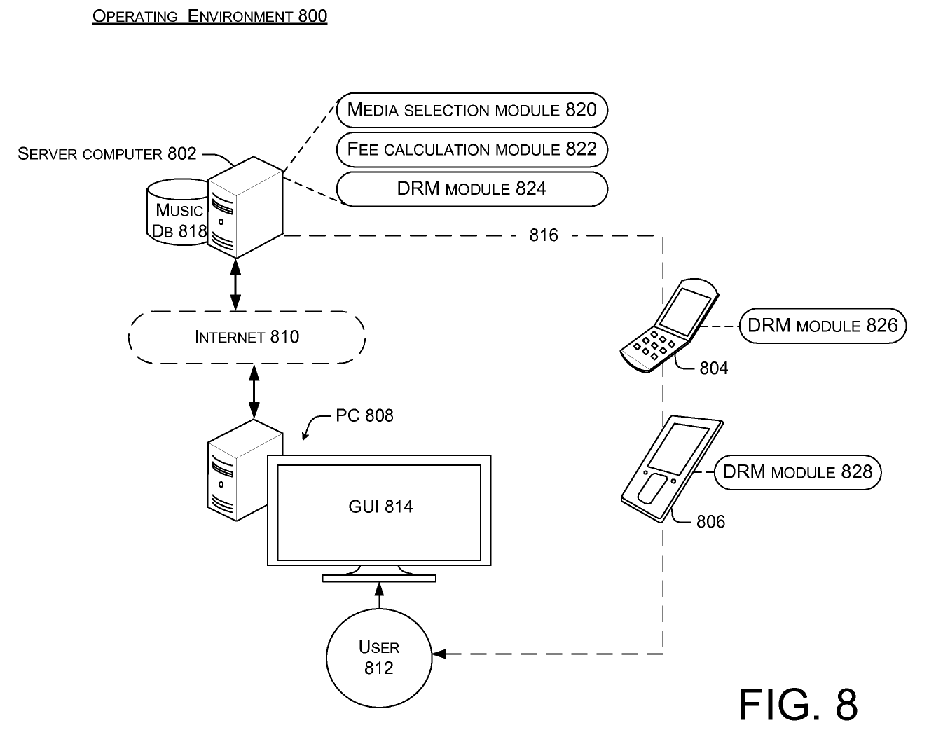

FIG. 8 shows an exemplary operating environment 800 in which the bulk media concepts described above and below can be implemented on various digital or computing devices. This example is directed to media in the form of music, but can be applicable to other forms of media such as video. In this case, the computing devices are manifest as a server computer 802, a smart phone 804 that can offer a media player device functionality, a media player device 806, and a personal computer 808.

For purposes of explanation, assume that personal computer (PC) 808 is coupled to server computer 802 via the Internet 810 or other communication means. Further assume that a user or consumer 812 uses PC 808 to access a bulk media web-site hosted by server computer 802. The server computer (via the web-site can cause a graphical user interface (GUI) 814 to be generated on PC 808 that allows the user to purchase bulk media. Examples of screenshots that can be generated as components of GUI 814 are described above in relation to FIGS. 2-7.

In this configuration, server computer 802 (directly or via the bulk media web-site) can enable user 812 to purchase bulk media that is loaded onto a selected media player device such as one of smart phone 804 and media player device 806 that is then delivered to the user as indicated by arrow 816. Two examples of media player devices are offered here to indicate that exemplary media player devices can be manifest in many different configurations such as a standalone configuration of media player device 806 or a combined functionality of smart phone 804.

Server computer 802 can include a music database (Db) 818, a media selection module 820, a fee calculation module 822 and a digital rights management (DRM) module 824. Further, the selected media player device 804 or 806 can have a DRM module indicated at 826 and 828 respectively.

The user can select from media player devices offered on GUI 814. For purposes of explanation, assume that the user selected media player device 806. Media selection module 820 and database 818 can generate further screens on GUI 814 from which the consumer 812 can select songs to buy in bulk (i.e., user-selections) according to the terms or conditions described above in relation to FIGS. 2-7. The songs can include use restrictions imposed by digital rights management module 824 with the media player's DRM module 828. For instance, one condition may be that the song cannot be copied and that the song can only be played on media player device 806. DRM module 828 can contain a private key or serial number (i.e., unique identification number) that DRM module 824 associates with the songs to restrict use. Further, this configuration allows the user's songs to be resupplied in special cases. For instance, DRM module 824 can associate the media player device's private key with a list of the user's selected songs. If the media player device should fail during a warranty period, the list can be utilized to load the songs onto a replacement media player device to be supplied to the user. In such a configuration, the user can have use of the songs at least for the original warranty period defined in the purchase agreement (discussed above in relation to FIG. 4) and/or as long as the media player device continues to function (i.e., for a lifespan of the media player device).

Fee calculation module 822 can calculate fees or payments due for the bulk media loaded on the media player device 806. Once payment is received, the preloaded media player device can be sent to the user as indicated by arrow 816.

Bulk media systems can be appealing to user 812 even when compared to the user obtaining music for free from other sources. With the present implementations, songs can be supplied so inexpensively in bulk and preloaded for the user that the convenience can outweigh the cost. In fact, even in scenarios where the user already possesses media, such as on a PC or another media player, the bulk media pricing model and associated convenience of preloading can cause the user to have even the media that he/she already possesses preloaded on the selected media player device.

### CONCLUSION

Although techniques, methods, devices, systems, etc., pertaining to bulk media scenarios are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a fee calculation module configured to track user selections of media for storage on a media player device and to charge the user based on an amount of storage used for the user-selected media; and,
a digital rights management module configured to restrict use of the user-selected media to the media player device.

2. The system of claim 1, wherein the fee calculation module is configured to charge the user a flat service fee plus a fee per unit of storage for storing the user-selected media on the media player device.

3. The system of claim 1, wherein the fee calculation module and the digital rights management module reside on a computing device from which the user-selected media is obtained.

4. The system of claim 1, wherein the digital rights management module is configured to store a unique identification from the media player device and the user-selected media.

5. The system of claim 1, wherein the digital rights management module is configured to cause the user-selected media to be installed on a replacement media player device in an instance where the media player device fails within a warranty period.

6. The system of claim 5, wherein the digital rights management module is configured to cause the user-selected media installed on the replacement media player device to only be playable during a remainder of the warranty period.

7. A computer-readable storage media having instructions stored thereon that when executed by a computing device cause the computing device to perform acts, comprising:
allowing a user to select songs to be installed on a media player device;
installing the selected songs on the media player device; and,
charging the user for the selected songs based on an amount of storage that the selected songs occupy on the media player device.

8. The computer-readable storage media of claim 7, wherein the allowing comprises generating a listing of songs from which the user can select individual songs or groups of songs.

9. The computer-readable storage media of claim 7, wherein the installing comprises installing the selected songs on the media player device so that the selected songs can only be played on that individual media player device.

10. The computer-readable storage media of claim 7, wherein the installing comprises installing the selected songs on the media player device with a use-restriction so that the selected songs can be played on that individual media player device as long as the individual media player device continues to function but the selected songs cannot be copied by the user.

11. The computer-readable storage media of claim 9, wherein the charging comprises charging a flat service fee and a storage fee, wherein the flat service fee covers licensing royalties for the selected songs and the flat service fee does not change depending on a number of selected songs and wherein the storage fee is based upon a number of gigabytes of storage occupied by the selected songs.

12. A method, comprising:
allowing a user to select a media player device to purchase and to select an amount of media storage capacity for the media player device; and,
enabling the user to select songs to be automatically installed on the media player device to fill at least a portion of the media storage capacity wherein the user is charged a fee for installing the selected songs on the media player device.

13. The method of claim 12, wherein the allowing comprises allowing the user to select the amount of media storage capacity in gigabytes.

14. The method of claim 12, wherein the enabling comprises enabling the user to select one or more of: individual songs and groups of songs.

15. The method of claim 12, wherein the fee is a flat service fee for automatically installing the selected songs on the media player device.

16. The method of claim 12, wherein the fee reflects a number of gigabytes of media storage capacity occupied by the selected songs on the media player device.

17. The method of claim 12, wherein the fee comprises a flat service fee component for automatically installing the selected songs on the media player device and a fee component per gigabyte of storage capacity occupied by the selected songs on the media player device.

18. The method of claim 12, further comprising automatically installing the selected songs on the media player device subject to a use-restriction so that the user can play the selected songs on the media player device for a life of the media player device but the user cannot copy the selected songs.

19. The method of claim 18, wherein the automatically installing comprises associating a unique identification of the media player device with the installed songs such that in an instance where the media player device fails during a warranty period the installed songs can be installed on a replacement media player device.

20. The method of claim 19, wherein the songs installed on the replacement media player device become unplayable on the replacement media player device at the end of the warranty period.
